(19) United States
(12) Patent Application Publication
(10) Pub. No.: US 2026/0104930 A1
(43) Pub. Date: Apr. 16, 2026

(54) Artificial Intelligence to Linear System Processing

(71) Applicant: International Business Machines Corporation, Armonk, NY (US)

(72) Inventors: Siddharth K. Saraya, Raniganj (IN); Mukundan Sundararajan, Bangalore (IN)

(21) Appl. No.: 18/916,883

(22) Filed: Oct. 16, 2024

(51) Int. Cl. G06F 9/50

(52) U.S. Cl. CPC G06F 9/5027

(57) ABSTRACT

A method initiates operation of a linear system from an artificial intelligence system. A set of dynamic execution parameters is monitored during an execution of the artificial intelligence system that provides outputs using inputs to the artificial intelligence system. Processing of the inputs is switched from the artificial intelligence system to the linear system that provides the outputs using the inputs in response to the set of dynamic execution parameters meeting a threshold for a stable operation in the artificial intelligence system. According to other illustrative embodiments, a computer system and a computer program product initiates operation of a linear system from an artificial intelligence system are provided.

### BACKGROUND

The disclosure relates generally to an improved computer system and more specifically to processing input data using artificial intelligence systems and linear systems, and in particular for a system for switching from an artificial intelligence to a linear system to process input data.

An artificial intelligence system is a computer system that can simulate intelligent behavior such as a human being. An artificial intelligence system can process data, learn from the data being processed, and make decisions or perform tasks that typically require human intelligence. Artificial intelligence systems have been used to process information such that tasks can be offloaded from persons to these systems. Artificial intelligence systems can include, for example, machine learning models, fuzzy logic systems, expert systems, swarm intelligence, evolutionary algorithms, and other types of systems. Artificial intelligence systems can operate to identify and solve complex problem sets with sets of data having fuzzy boundaries.

Artificial intelligence systems can operate to use input data that are complex and varied in a manner that adapts to these different types of data. Artificial intelligence systems can be particularly useful when multiple dependent variables are present. In these situations, artificial intelligence systems can identify and correlate dependent variables in processing inputs to generate an output.

### SUMMARY

According to one illustrative embodiment, a method initiates operation of a linear system from an artificial intelligence system. A set of dynamic execution parameters is monitored during an execution of the artificial intelligence system that provides outputs using inputs to the artificial intelligence system. Processing of the inputs is switched from the artificial intelligence system to the linear system that provides the outputs using the inputs in response to the set of dynamic execution parameters meeting a threshold for stable operation in the artificial intelligence system. According to other illustrative embodiments, a computer system and a computer program product for initiating operation of a linear system from an artificial intelligence system are provided.

### BRIEF DESCRIPTION OF THE DRAWINGS

FIG. 1 is a block diagram of a computing environment in accordance with an illustrative embodiment;

FIG. 2 is a block diagram of an information processing environment in accordance with an illustrative embodiment;

FIG. 3 is an illustration of an artificial intelligence to linear system converter in accordance with an illustrative environment;

FIG. 4 is a flowchart of a process for monitoring dynamic execution parameters during execution of an artificial intelligence system in accordance with an illustrative embodiment;

FIG. 5 is a flowchart of a process for analyzing the flow of code through paths and an artificial intelligence system in accordance with an illustrative embodiment;

FIG. 6 is a flowchart of a process for stability interpretation in accordance with an illustrative embodiment;

FIG. 7 is a flowchart of a process for initiating operation of the linear system to process inputs in place of an artificial intelligence system in accordance with an illustrative embodiment;

FIG. 8 is a flowchart of a process for monitoring the set of execution parameters in accordance with an illustrative embodiment;

FIG. 9 is a flowchart of a process for switching processing of inputs in accordance with an illustrative embodiment;

FIG. 10 is a flowchart of a process for monitoring a set of dynamic execution parameters in accordance with an illustrative embodiment;

FIG. 11 is a flowchart of a process for switching processing in accordance with an illustrative embodiment; and

FIG. 12 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

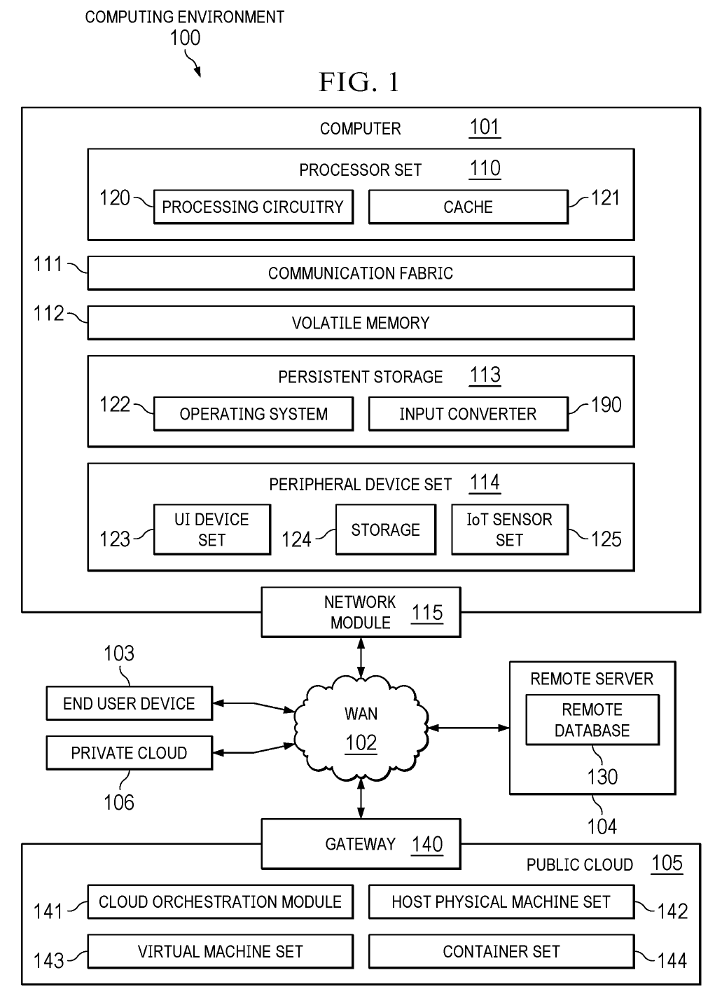

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as input converter 190. In addition to input converter 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and input converter 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in input converter 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in input converter 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Although artificial intelligence systems provide an ability to handle complex and nonlinear relationships in data such as those with multiple dependent variables, artificial intelligence systems have drawbacks. For example, an artificial intelligence system has a higher complexity and uses significantly more computational resources as compared to a linear system. In other words, cost of execution is greater for an artificial intelligence system.

In some cases, an artificial intelligence system can attain a level of maturity that enables using a linear system in place of the artificial intelligence system. A linear system can be used in place of the artificial intelligence system when the artificial intelligence system has reached a stable operation. A stable operation can be determined by the number of cases of false outcomes, the presence of very little bias corrections, and outcomes being explainable in terms of the different inputs. For example, when the output provided by an artificial intelligence system has a level of correctness for a particular category of inputs over some period of time. This type of operation by the artificial intelligence system can indicate a temporal validity of the output for that category of inputs. This type of operation can indicate that the artificial intelligence system has reached stable operation. In this case, a linear system can be in place of the artificial intelligence system for that category of inputs.

Thus, the illustrative examples provide a method, apparatus, system, and computer program product for procuring using a linear system in place of an artificial intelligence system. In the illustrative example, this change in operation can be initiated in response to determining that the artificial intelligence system has attained stable operation in which the complexity and resource use of the artificial intelligence system is not needed. In one illustrative example, this change in operation can be a change from using the artificial intelligence system to using a linear system to reduce the use of computational resources.

In one illustrative example, stable operation of the artificial intelligence system can be identified through measuring a set of dynamic execution parameters during an execution of the artificial intelligence system and comparing those dynamic execution parameters to thresholds indicating when stable operation is present. As used herein, a “set of” when used with reference items means one more items. For example, a set of dynamic execution parameters is one or more dynamic execution parameters.

These dynamic execution parameters can include at least one of a stability parameter or a new path flow parameter. The stability parameter can measure variance of an output in the artificial intelligence system for a category of inputs. The new flow parameter can indicate when execution of the artificial intelligence system results in a new path being used was not previously used during the period of time during which execution of the artificial intelligence system is measured. When the dynamic execution parameters meet a threshold indicating that the use of a linear system is suitable, then the processing of inputs for a category of data can be switched to a linear system.

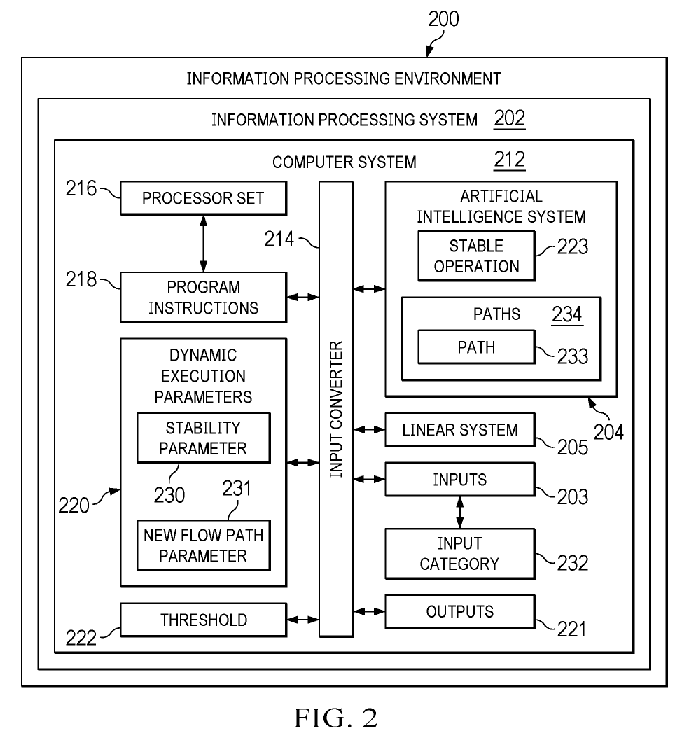

With reference now to FIG. 2, a block diagram of an information processing environment is depicted in accordance with an illustrative embodiment. In this illustrative example, information processing environment 200 includes components that can be implemented in hardware such as the hardware shown in computing environment 100 in FIG. 1. In this example, information processing system 202 can operate to manage processing of inputs 203 using artificial intelligence system 204 and linear system 205 to generate outputs 221.

In this example, artificial intelligence system 204 is a computational system with functions typically associated with human intelligence. Artificial intelligence system 204 can perform at least one of learning, reasoning, problem-solving, perception, language understanding, or other types of analysis or operations. In this example, artificial intelligence system 204 can be implemented using at least one of a machine learning model, an expert system, a rule based system, an evolutionary algorithm, a swarm intelligence system, a search algorithm, a fuzzy logic system, or other types of computational systems.

Further in this example, linear system 205 is a mathematical system. This system can comprise one or more equations. For example, linear system 205 can include at least one of a set of equations, an nth degree polynomial equation, a linear equation, or other suitable type of equation.

In this illustrative example, information processing system 202 comprises computer system 212 and input converter 214. As depicted, input converter 214 is located in computer system 212. Input converter 214 may be implemented using input converter 190 in FIG. 1.

Input converter 214 can be implemented in software, hardware, firmware, or a combination thereof. When software is used, the operations performed by input converter 214 can be implemented in program instructions configured to run on hardware, such as a processor unit. When firmware is used, the operations performed by input converter 214 can be implemented in program instructions and data and stored in persistent memory to run on a processor unit. When hardware is employed, the hardware can include circuits that operate to perform the operations in input converter 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

Input converter 214 can initiate operation of linear system 205 to process inputs 203 in place of artificial intelligence system 204. In this example, input converter 214 monitors a set of dynamic execution parameters 220 during an execution of artificial intelligence system 204. In this example, the monitoring of the set of dynamic execution parameters 220 is performed during an execution of the artificial intelligence system that generates outputs 221 based on inputs 203 made to artificial intelligence system 204. Input converter 214 switches processing of inputs 203 from artificial intelligence system 204 to linear system 205 that provides outputs 221 using inputs 203 in response to the set of dynamic execution parameters 220 meeting a threshold 222 for stable operation 223 in artificial intelligence system 204.

In this illustrative example, stable operation 223 can be considered present when outputs 221 are generated with a low enough variation fluctuation in response to inputs 203 from input category 232. In these examples, the amount of variation acceptable for stable operation 223 is set by threshold 222. For example, if the variation in outputs 221 is within threshold 222 in response to receiving different inputs in input category 232, then artificial intelligence system 204 is considered to have stable operation 223. In these examples, threshold 222 can be set by a user.

Input converter 214 can monitor the set of dynamic execution parameters 220 for paths 234 in artificial intelligence system 204 during the execution of artificial intelligence system 204. In other words, the same dynamic execution parameters can be measured or determined for each path in paths 234.

In this example, the set of dynamic execution parameters 220 comprises at least one of stability parameter 230, new flow path parameter 231, or some other suitable parameter that can be used to determine whether stable operation 223 is present in artificial intelligence system 204. In this example, stable operation 223 can be present when variance in outputs 221 is less than some selected amount with respect to inputs 203 that are in the same category. Further, in this example, stable operation 223 can also occur when the number of new paths detected during execution of artificial intelligence system 204 is less than some selected amount. The selected amount can be set using threshold 222. Thus, when different variations of inputs 203 in input category 232 are used, little-or no new paths can occur indicating stable operation.

With this example, input converter 214 switches processing of inputs 203 for input category 232 from artificial intelligence system 204 to linear system 205 in response to stability parameter 230 and new flow path parameter 231 being within threshold 222. In some examples, a single dynamic execution parameter may be used to determine when switching occurs.

In these examples, stability parameter 230 is always monitored for paths 234 in artificial intelligence system 204. This parameter is tied to an individual or group of paths that are part of the entire flow. Thus, this parameter indicates the stability of variations to ensure that those variations are within a tolerable range of acceptance that makes it suitable to use linear system 205.

In this example, stability parameter 230 indicates a variance between outputs 221 for path 233 during the execution of the artificial intelligence system 204 to process inputs 203 in input category 232. In this example, a path is a specific sequence of steps or operations that artificial intelligence system 204 follows during execution to process inputs 203. Threshold 222 for stability parameter 230 can be selected to have a value that indicates reliability of obtaining correct outputs from the linear system 205.

In these examples, stability parameter 230 is always monitored for paths 234 in artificial intelligence system 204. This parameter is tied to an individual or group of paths 234 that are part of an entire flow of steps. This parameter indicates the stability of variations to ensure that those variations are within a tolerable range of acceptance that makes it suitable to use linear system 205.

Further in this example, new flow path parameter 231 indicates the addition of new paths to paths 234 during the monitoring of execution of artificial intelligence system 204 over a period of time. In this example, a new path can occur using inputs 203 in input category 232. In these examples, this parameter is used to identify paths that are traversed within paths 234 in response to inputs 203 from input category 232. The detection of new paths can indicate that artificial intelligence 204 has not matured sufficiently to provide stable operation 223 in processing inputs 203. Threshold 222 for new flow path parameter 231 can be selected to indicate stable operation 223 is present because the level or number of new paths that are detected during the execution of artificial intelligence system 204 over a period of time is low enough to indicate that maturity or stable operation 223 is present in artificial intelligence system 204.

In this example, new paths that are identified during the monitoring are also monitored for stability through stability parameter 230. The new paths can occur in response to input variations to inputs 203 in input category 232.

In this example, inputs 203 are in input category 232. Input converter 214 monitors stability parameter 230 in the set of dynamic execution parameters 220 for path 233 in paths 234 in artificial intelligence system 204 over a period of time for inputs 203 in input category 232.

With this example, stability parameter 230 indicates a variance between outputs for path 233 during the execution of artificial intelligence system 204 for inputs 203 in input category 232. In this example, stability parameter 230 can indicate a variance in the outputs generated from inputs 203 in the same input category.

For example, a higher value indicates less variance as compared to a lower value. Thus, higher values such as 0.9 or 0.95 indicates a lower variance as compared to a value of 0.6 for stability parameter 230. In this example, the higher value indicates more stability in path 233. This type of monitoring can be performed for each path within artificial intelligence system 204.

In this example, input converter 214 monitors new flow path parameter 231 in the set of dynamic execution parameters 220 over the period of time. In this case, new flow path parameter 231 indicates an addition of a new path to paths 234 being monitored that generates the output. In one illustrative example, a presence or one or more new paths can result in a need to determine the stability for each new path that occurs.

In one example, input converter 214 identifies a set of paths 234 in artificial intelligence system 204 in which the set of dynamic execution parameters 220 meet a threshold for a stable operation of the set of paths 234. Input converter 214 switches processing of inputs 203 for set of paths 234 in artificial intelligence system 204 to the linear system 205 in response to the set of dynamic execution parameters 220 meeting the threshold. In one illustrative example, the set of paths 234 can be related to each other.

For example, the set of paths 234 and artificial intelligence system 204 can comprise an outer path and the number of inner paths. These inner paths can be nested paths within the outer path. Each of these paths can have a dynamic stability parameter. With this example, dynamic execution parameters 220 of all of the paths in the set of paths 234 meet threshold 222 for stable operation 223.

In the illustrative example, stable operation 223 of artificial intelligence system 204 can be for portions of artificial intelligence system 204 such as the set of paths 234. With this example, the switching of the processing of inputs 203 is performed for inputs 203 to the set of paths 234. These inputs are part of input category 232. These inputs are switched to linear system 205. Other inputs from other paths in paths 234 in artificial intelligence system 204 are still processed using artificial intelligence system 204 with those paths in paths 234 that do not have stable operation 223.

Computer system 212 can be configured to perform at least one of the steps, operations, or actions described in the different illustrative examples using software, hardware, firmware, or a combination thereof. As a result, computer system 212 operates as a special purpose computer system in which input converter 214 in computer system 212 enables switching from an artificial intelligence system to a linear system in manner that provides desired accuracy and outputs while reducing at least one of the amount of processing time or use of resources. In particular, input converter 214 transforms computer system 212 into a special purpose computer system as compared to currently available general computer systems that do not have input converter 214.

In the illustrative example, the use of input converter 214 in computer system 212 integrates processes into a practical application for processing inputs using an artificial intelligence system in which processing inputs can be switched from the artificial intelligence system to a linear system that increases the performance of computer system 212. In other words, input converter 214 in computer system 212 is directed to a practical application of processes integrated into input converter 214 in computer system 212 that determines whether stable operation is present in the artificial intelligence system. In response to stability in the operation of the artificial intelligence system, the processing of inputs by portions or all of the artificial intelligence system can be switched to a linear system. In this manner, at least one of the amount of processing resources or time needed to form processing of inputs can be reduced.

The illustration of information processing environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, input converter 214 can manage the processing inputs by of one or more artificial intelligence systems in addition to artificial intelligence system 204. In yet another illustrative example, different thresholds may be used for different paths within artificial intelligence system 204.

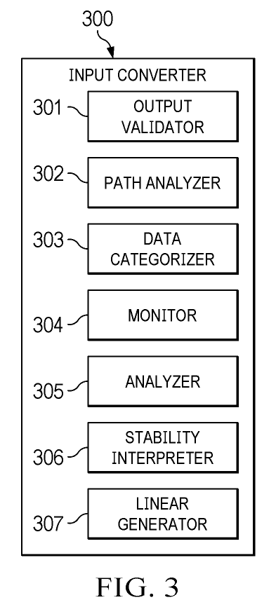

With reference next to FIG. 3, an illustration of an artificial intelligence to linear system converter is depicted in accordance with an illustrative environment. In this illustrative example, input converter 300 is an example of an implementation of input converter 214 in FIG. 2. As depicted, input converter 300 comprises output validator 301, path analyzer 302, data categorizer 303, monitor 304, analyzer 305, stability interpreter 306, and linear generator 307.

In this example, output validator 301 processes the correctness of outputs from an artificial intelligence system. In this example, output validator 301 can map the output with the expected output in determining whether the output is correct. In some illustrative examples, user input can be used to determine the expected output. In other words, the user can determine whether the output from the artificial intelligence engine is correct. Further, this component can also record different results with reasons for variation as false outcomes.

Output validator 301 can also determine the temporal validity of the output using the validation of prepreg outcomes, false outcomes, retraining frequency, and other information. This temporal validity may be used to determine whether the artificial intelligence system should be retrained or undergo further training.

In this example, path analyzer 302 analyzes the flow of code within the artificial intelligence system. This analysis of the flow is used to determine paths that occur during the execution of the artificial intelligence system. For example, path analyzer 302 can enter different inputs into the artificial intelligence system causing the flow of execution to traverse through a different path in the artificial intelligence system.

These paths can traverse nodes. In this example, each node represents a distinct point or operation in the execution flow, such as assignments, function calls, or branching decisions like loops or conditional statements. The combination of all of the nodes that are encountered during this process defines the entire path for that specific execution in the artificial intelligence system. As a result, the path is the set of all nodes visited as the artificial intelligence system operates, reflecting the complete sequence of execution for that test or function.

Further, path analyzer 302 can also track how often the path is traversed. A counter can be incremented each time a path is traversed from entering inputs into the artificial intelligence system.

Further, in analyzing paths, path analyzer 302 can also determine when different paths are nested, sequential, or parallel. The most granular level of a path is identified in which inputs and outputs are for the path. This granular level of flow can be considered as a node or flow for the superseding path.

Next, data categorizing 303 operates to categorize or group variations in inputs to the artificial intelligence system. In this example, a category of inputs are inputs that use the same path. As a result, inputs can be a range of values for taking paths that causes a particular path to be followed. In these examples, all of the inputs in a path, including nested under the path, are in the same category. The outermost path is referred to as the outer path and the number of other paths within the outer path are referred to as a number of inner paths.

Thus, input categories of inputs can be identified based on the path taken during execution of the artificial intelligence system. For example, a first input can traverse a path with that input being for a particular input category. If that path is not traversed with that next input, the flow of the code has changed based on the next input. As a result, this next input is classified as a new input category as compared to the prior input. The output can be different or the same from post processing of the inputs in the various paths. Thus, in these examples, input categories are based on inputs that cause execution of code through a particular path in the artificial intelligence system.

In this example, monitor 304 monitors the execution of the artificial intelligence system over some selected period of time. In this example, monitor 304 monitors dynamic execution parameters such as a stability parameter and a new flow path parameter.

For example, the stability parameter can be measured during the monitoring for a variance in the output for a particular path in response to the input for an input category. Depending on the amount of variance, a value is determined for the stability parameter for a particular path. In one illustrative example, the value of the stability parameter increases as the variance in output decreases from the inputs for input category for the path. If the level of variance is continuous, then the path is not yet considered mature. The amount of variance needed for stability can be set by a threshold.

In this example, the new flow path parameter is used to identify execution that uses a new path during the period of time for which monitoring is performed. The new flow path parameter can be a counter in which the counter is incremented each time a new path is used during execution of the artificial intelligence system

This parameter can be used to determine whether the artificial intelligence system is considered to have a stable operation. For example, as the value for the new flow path parameter increases, the artificial intelligence system can be considered to be still maturing and the paths for a particular input category are not yet considered to have stable operation. Further, this parameter can also be used to identify new paths for which monitoring for stability parameters occurs.

The use of a new input in a category can result in a new path being occurring. Also, the paths in the artificial intelligence system are typically known. However, in some cases a path may not have been logically identified or known by the programmer.

In this example, monitor 304 compares the stability parameter and the new flow path parameter to a threshold for these parameters. In one example, these parameters are a set of values from 0 to 1. A “1” indicates the greatest stability for the path and 0 is a lowest level of new path current for the new flow path parameter. In other examples, other values can be used for categories. Each parameter can have a different threshold in these examples. Thus, monitor 304 can indicate whether a particular path or an outer path with inner paths have stable operation.

Next, analyzer 305 uses the report of stable or unstable operation from monitor 304 to identify path groups that have stable operation. For example, the values for the different paths that have stable operation can be analyzed to determine whether a particular path has inner paths. Thus, analyzer 305 can be grouped together on this basis to form a path group. In this example, paths in a path group can also be sequential or parallel. For example, two sequential paths can be inner paths with the overall flow through these two sequential paths being the outer path. In another example, two parallel paths can be inner paths with overall flow through these two parallel paths being the outer path. These outer and inner paths form a path group.

This grouping of paths by analyzer 305 can be performed using inputs in input categories. In this manner, different paths for which operation are present can be analyzed to identify path groups that can include nested paths, sequential paths, or parallel paths. A path group can comprise one or more paths in these examples. In this example, the nested, sequential, and parallel paths that have an outer path and inner paths. The identification of these paths can be sent to stability interpreter 306 for analysis of whether each of these paths have stable operation.

In this example, stability interpreter 306 determines whether a particular path group identified by analyzer 305 has a stable operation. In this example, stability interpreter 306 can make this determination by analyzing the stable operation parameter for each of the paths in a path group. In this manner, determination of whether a path group has stable operation can be determined by stability interpreter 306. For example, when the path group includes an outer path and inner paths, the analysis for stability is performed for the outer path and each of the inner paths in the path group.

Path groups with a stable operation are sent to linear generator 307 by stability interpreter 306. In this example, linear generator 307 uses identification of a path group to trigger or initiate switching of processing of inputs for that path group to a linear system that corresponds to the path group. If a corresponding linear system is not present, linear generator 307 can generate a message or indication that a linear system is needed for that group path in the artificial intelligence system.

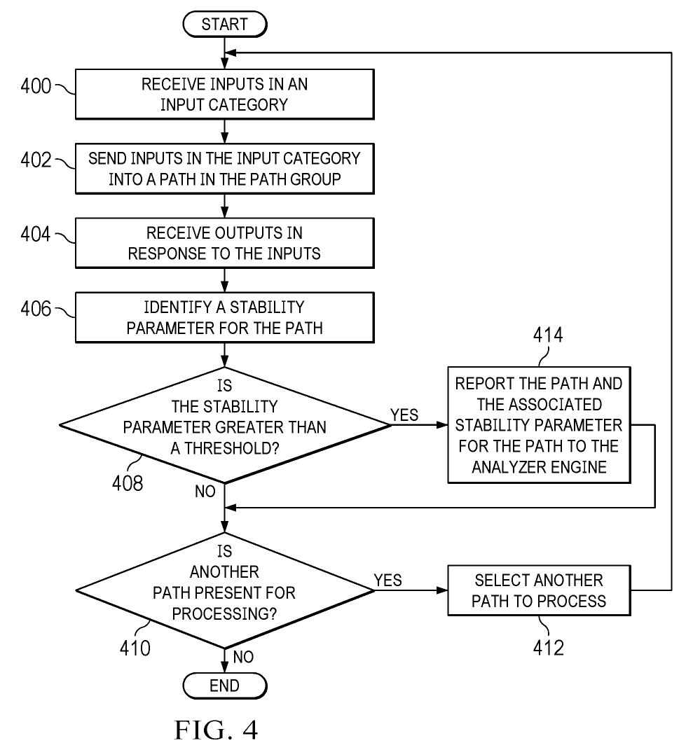

Turning next to FIG. 4, a flowchart of a process for monitoring dynamic execution parameters during execution of an artificial intelligence system is depicted in accordance with an illustrative embodiment. The process in this flowchart is an example of steps that can be used to implement monitor 304 in FIG. 3. The process in this flowchart is for a path in the artificial intelligence system. This path can be a path in a path group that has an outer path in one or more paths.

The process begins by receiving inputs in an input category (step 400). In this example, the inputs in an input category can be for a path group comprising one or more paths. The process sends inputs in the input category into a path in the path group (step 402). The process receives outputs in response to the inputs (step 404).

The process identifies a stability parameter for the path (step 406). In step 406, the stability parameter is based on the fluctuation or differences in the output with respect to inputs from the input category. In this example, the stability parameter can be valued from 0 to 1 in which 1 represents the highest level of stability in which a variation in the output is nonexistent with respect to the inputs in the input category. That is, the higher the value indicates a higher level of stability for that path.

A determination is made as to whether the stability parameter is greater than a threshold (step 408). This threshold is selected as a value that indicates sufficient stability was present for stable operation of the path using different inputs in the category. If the path is not stable, the process determines whether another path is present for processing (step 410). If another path is present for processing, the process selects another path to process (step 412) and returns to step 400. In step 408, if the path is stable, the path and the associated stability parameter for the path is reported to the analyzer engine (step 414). The process then proceeds to step 410 as described above. With reference again to step 410, if another path is not present for processing, the process terminates. In this case, all the paths identified in the artificial intelligence system had been processed.

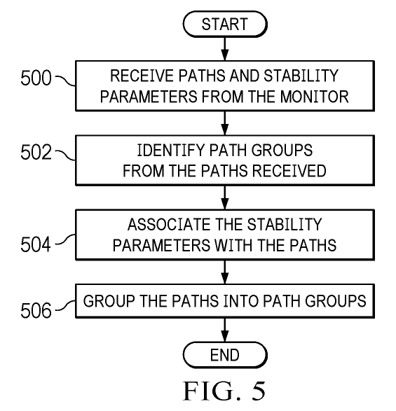

Next in FIG. 5, a flowchart of a process for analyzing the flow of code through paths and an artificial intelligence system is depicted in accordance with an illustrative embodiment. This process is an example of steps that can be used to implement monitor 304 in FIG. 3.

The process begins by receiving paths and stability parameters from the monitor (step 500). The process identifies path groups from the paths received (step 502). In this example, a path group comprises a number of paths that have inputs from the same input category. In some cases, a path group has a single path while in other cases, the path group has an outer path and two or more inner paths.

The process associates the stability parameters with the paths (step 504). The process then groups the paths into path groups (step 506). The process terminates thereafter. In step 506, a path group can include one or more paths. Further, a path group can be nested paths, parallel paths, and sequential paths.

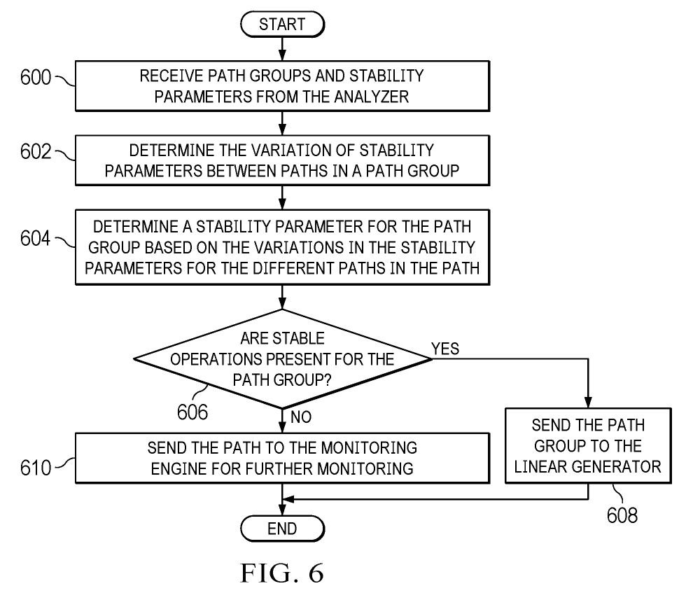

Turning now to FIG. 6, a flowchart of a process for stability interpretation is depicted in accordance with an illustrative embodiment. The process in this flowchart is an example of steps that can be used to implement stability interpreter 306 in FIG. 3.

The process begins by receiving path groups and stability parameters from the analyzer (step 600). The process then determines the variation of stability parameters between paths in a path group (step 602). For example, a path group can include an outer path and inner paths. Each of these paths has a stability parameter. The variation between the stability parameters are compared.

The process determines a stability parameter for the path group based on the variations in the stability parameters for the different paths in the path (step 604). For example, the stability parameter for each path can be compared to a threshold. For example, a path group includes an outer path and inner paths, and the stability parameter for the outer path is compared to a threshold. Additionally, the stability parameter for each inner path is also compared to a threshold. This threshold can be the same or a different threshold depending on the implementation. In another example, the stability parameters for each path in the path group can be averaged, interpolated, or analyzed in some other manner to obtain a single stability parameter for the overall path group. This single stability parameter can then be compared to a threshold.

A determination is made as to whether stable operations are present for the path group (step 606). This process can include comparing the different stable parameters for the different paths to thresholds. Also, an overall stable parameter for an outer path.

If a stable operation is present for the path group, the process sends the path group to the linear generator (step 608). The process terminates thereafter. With reference again to step 606, if stable operation is not present, then the process sends the path to the monitoring engine for further monitoring (step 610). The process terminates thereafter.

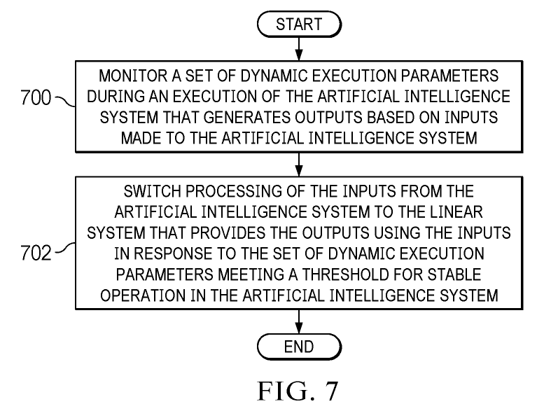

Turning next to FIG. 7, a flowchart of a process for initiating operation of the linear system to process inputs in place of an artificial intelligence system is depicted in accordance with an illustrative embodiment. The process in FIG. 7 can be implemented in hardware, software, or both. When implemented in software, the process can take the form of program instructions that are run by a processor set located in one or more hardware devices in one or more computer systems. For example, the process can be implemented in input converter 214 in computer system 212 in FIG. 2.

The process begins by monitoring a set of dynamic execution parameters during an execution of the artificial intelligence system that generates outputs based on inputs made to the artificial intelligence system (step 700). The process switches processing of the inputs from the artificial intelligence system to the linear system that provides the outputs using the inputs in response to the set of dynamic execution parameters meeting a threshold for stable operation in the artificial intelligence system (step 702). The process terminates thereafter.

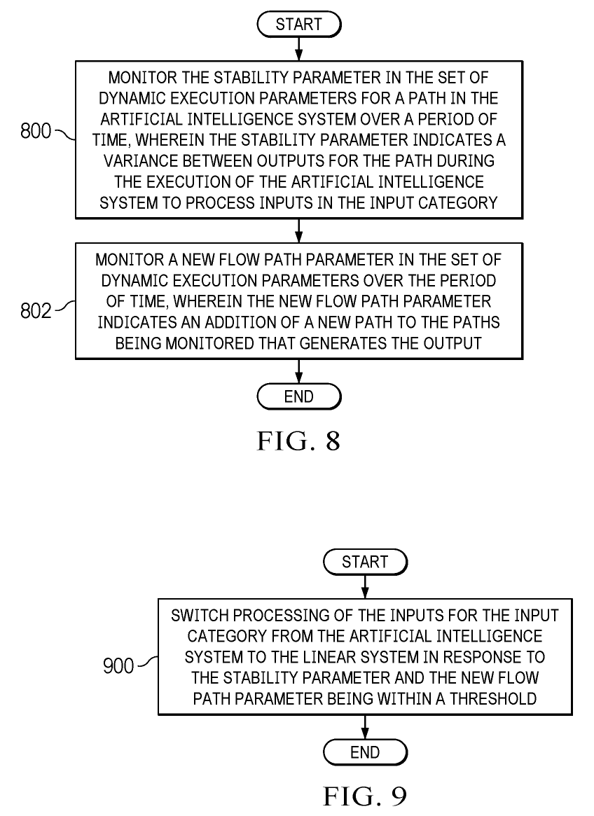

Turning now to FIG. 8, a flowchart of a process for monitoring the set of execution parameters is depicted in accordance with an illustrative embodiment. This flowchart is an example of an implementation for step 700 in FIG. 7. In this example, the inputs are in an input category. In other words, the inputs are in the same input category.

The process monitors the stability parameter in the set of dynamic execution parameters for a path in the artificial intelligence system over a period of time, wherein the stability parameter indicates a variance between outputs for the path during the execution of the artificial intelligence system to process inputs in the input category (step 800). The process monitors a new flow path parameter in the set of dynamic execution parameters over the period of time, wherein the new flow path parameter indicates an addition of a new path to the paths being monitored that generates the output (step 802). The process terminates thereafter.

With reference next to FIG. 9, a flowchart of a process for switching processing of inputs is depicted in accordance with an illustrative embodiment. This process is an example of an implementation for step 702 in FIG. 7 using the monitoring steps in FIG. 8.

The process switches processing of the inputs for the input category from the artificial intelligence system to the linear system in response to the stability parameter and the new flow path parameter being within a threshold (step 900). The process terminates thereafter.

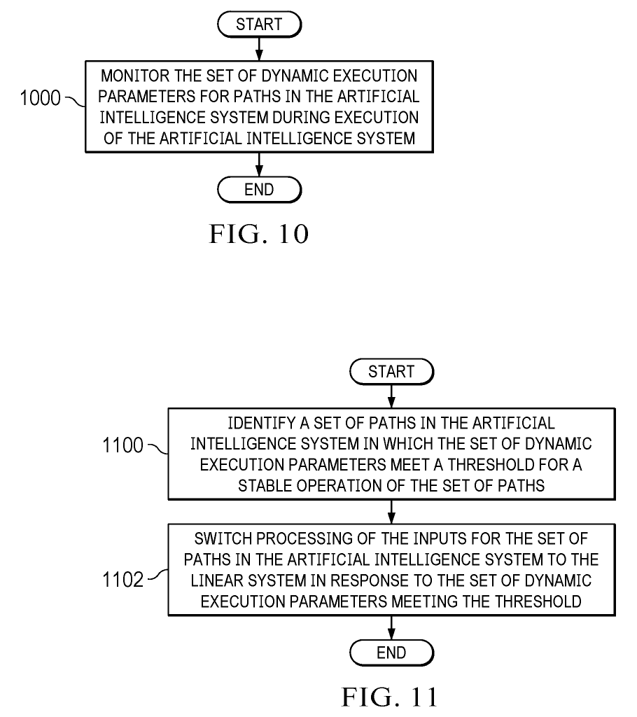

Next in FIG. 10, a flowchart of a process for monitoring a set of dynamic execution parameters is depicted in accordance with an illustrative embodiment. The process in this figure is an example of an implementation for step 700 in FIG. 7.

The process monitors the set of dynamic execution parameters for paths in the artificial intelligence system during execution of the artificial intelligence system (step 1000). The process terminates thereafter.

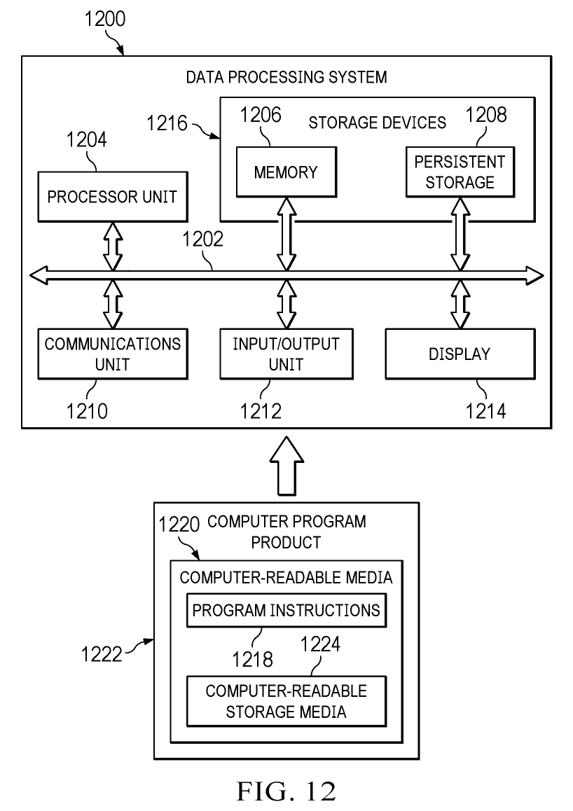

Turning now to FIG. 11, a flowchart of a process for switching processing is depicted in accordance with an illustrative embodiment. The process in this flowchart is an example of an implementation for step 702 in FIG. 7.

The process identifies a set of paths in the artificial intelligence system in which the set of dynamic execution parameters meet a threshold for a stable operation of the set of paths (step 1100). The process switches processing of the inputs for the set of paths in the artificial intelligence system to the linear system in response to the set of dynamic execution parameters meeting the threshold (step 1102). The process terminates thereafter. In step 1102, the set of paths in the artificial intelligence system comprises an outer path and a number of inner paths. In another example, the set of paths can also include parallel paths.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Turning now to FIG. 12, a block diagram of a data processing system is depicted in accordance with an illustrative embodiment. Data processing system 1200 can be used to implement computers and computing devices in computing environment 100 in FIG. 1. Data processing system 1200 can also be used to implement computer system 212 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer-readable program instructions that can be read and executed by a processor in processor unit 1204. The program instructions in the different embodiments can be embodied on different physical or computer-readable storage media, such as memory 1206 or persistent storage 1208.

Program instructions 1218 are located in a functional form on computer-readable media 1220 that is selectively removable and can be loaded onto or transferred to data processing system 1200 for execution by processor unit 1204. Program instructions 1218 and computer-readable media 1220 form computer program product 1222 in these illustrative examples. In the illustrative example, computer-readable media 1220 is computer-readable storage media 1224.

Computer-readable storage media 1224 is a physical or tangible storage device used to store program instructions 1218 rather than a medium that propagates or transmits program instructions 1218. Computer-readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1218 can be transferred to data processing system 1200 using a computer-readable signal media. The computer-readable signal media are signals and can be, for example, a propagated data signal containing program instructions 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program instructions 1218 can be located in computer-readable media 1220 in the form of a single storage device or system. In another example, program instructions 1218 can be located in computer-readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer-readable media 1220 in a server computer while another portion of program instructions 1218 can be located in computer-readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. In other examples, more than one processor unit can be present. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, illustrative embodiments provide a computer implemented method, computer system, and computer program product for managing the processing of inputs using an artificial intelligence system. In one illustrative example, a method initiates operation of a linear system from an artificial intelligence system. A set of dynamic execution parameters is monitored during an execution of the artificial intelligence system that provides outputs using inputs to the artificial intelligence system. Processing of the inputs is switched from the artificial intelligence system to the linear system that provides the outputs using the inputs in response to the set of dynamic execution parameters meeting a threshold for a stable operation in the artificial intelligence system. In one example, the stable operations present when the outputs do not have an undesired level variation in response to a range of inputs to the artificial intelligence system.

In these illustrative examples, the stable operation can be for one or more portions of the artificial intelligence system such as a path or paths in the artificial intelligence system. When stable operation of one or more portions of an artificial intelligence system is present, the processing of the inputs by those portions can be switched to a linear system. As a result, the amount of processing resources and time needed to process inputs can be reduced through the use of the linear system for those portions of the artificial intelligence system in which stable operation is present.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for initiating operation of a linear system to process inputs in place of an artificial intelligence system, the method comprising:
monitoring a set of dynamic execution parameters during an execution of the artificial intelligence system that generates outputs based on inputs made to the artificial intelligence system; and
switching a processing of the inputs from the artificial intelligence system to the linear system that provides the outputs using the inputs in response to the set of dynamic execution parameters meeting a threshold for a stable operation in the artificial intelligence system.

2. The method of claim 1, wherein the inputs are in an input category and wherein monitoring the set of dynamic execution parameters comprises:
monitoring a stability parameter in the set of dynamic execution parameters for a path in the artificial intelligence system over a period of time, wherein the stability parameter indicates a variance between the outputs for the path during the execution of the artificial intelligence system to process for inputs in the input category; and
monitoring a new flow path parameter in the set of dynamic execution parameters over the period of time, wherein the new flow path parameter indicates an addition of a new path to the paths being monitored that generates the outputs.

3. The method of claim 2, wherein switching the processing comprises:
switching the processing of the inputs for the input category from the artificial intelligence system to the linear system in response to the stability parameter and the new flow path parameter being within the threshold.

4. The method of claim 1, monitoring the set of dynamic execution parameters comprises:
monitoring the set of dynamic execution parameters for paths in the artificial intelligence system during execution of the artificial intelligence system.

5. The method of claim 1, wherein switching the processing comprises:
identifying a set of paths in the artificial intelligence system in which the set of dynamic execution parameters meet a threshold for the stable operation of the set of paths; and
switching the processing of the inputs for the set of paths in the artificial intelligence system to the linear system in response to the set of dynamic execution parameters meeting the threshold.

6. The method of claim 5, wherein the set of paths in the artificial intelligence system comprises an outer path and a number of inner paths.

7. The method of claim 1, wherein the set of dynamic execution parameters comprises at least one of a stability parameter or a new flow path parameter.

8. The method of claim 1, wherein the linear system is selected from at least one of a set of equations, an nth degree polynomial equation, or a linear equation.

9. A computer system comprising:
a processor set;
a set of one or more computer-readable storage media; and
program instructions, collectively stored in the set of one or more storage media to cause the processor set to perform operations comprising:
monitoring a set of dynamic execution parameters during an execution of an artificial intelligence system that generates outputs based on inputs made to the artificial intelligence system; and
switching processing of the inputs from the artificial intelligence system to a linear system that provides the outputs using the inputs in response to the set of dynamic execution parameters meeting a threshold for a stable operation in the artificial intelligence system.

10. The computer system of claim 9, wherein the inputs are in an input category and wherein monitoring the set of dynamic execution parameters comprises:
monitoring a stability parameter in the set of dynamic execution parameters for a path in the artificial intelligence system over a period of time, wherein the stability parameter indicates a variance between the outputs for the path during the execution of the artificial intelligence system to process for inputs in the input category; and
monitoring a new flow path parameter in the set of dynamic execution parameters over the period of time, wherein the new flow path parameter indicates an addition of a new path to the paths being monitored that generates the outputs.

11. The computer system of claim 10, wherein switching the processing comprises:
switching the processing of the inputs for the input category from the artificial intelligence system to the linear system in response to the stability parameter and the new flow path parameter being within the threshold.

12. The computer system of claim 9, monitoring the set of dynamic execution parameters comprises:
monitoring the set of dynamic execution parameters for paths in the artificial intelligence system during execution of the artificial intelligence system.

13. The computer system of claim 9, wherein switching the processing comprises:
identifying a set of paths in the artificial intelligence system in which the set of dynamic execution parameters meet a threshold for a stable operation of the set of paths; and
switching the processing of the inputs for the set of paths in the artificial intelligence system to the linear system in response to the set of dynamic execution parameters meeting the threshold.

14. The computer system of claim 13, wherein the set of paths in the artificial intelligence system comprises an outer path and a number of inner paths.

15. The computer system of claim 9, wherein the set of dynamic execution parameters comprises at least one of a stability parameter or a new flow path parameter.

16. The computer system of claim 9, wherein the linear system is selected from at least one of a set of equations, an nth degree polynomial equation, or a linear equation.

17. A computer program product for initiating operation of a linear system to process inputs in place of an artificial intelligence system, the computer program product comprising:
a set of one or more computer-readable storage media; and
program instructions stored on the set of one or more storage media to perform operations comprising:
monitoring a set of dynamic execution parameters during an execution of the artificial intelligence system that generates outputs based on inputs made to the artificial intelligence system; and
switching a processing of the inputs from the artificial intelligence system to the linear system that provides the outputs using the inputs in response to the set of dynamic execution parameters meeting a threshold for a stable operation in the artificial intelligence system.

18. The computer program product of claim 17, wherein the inputs are in an input category and wherein monitoring the set of dynamic execution parameters comprises:
monitoring a stability parameter in the set of dynamic execution parameters for a path in the artificial intelligence system over a period of time, wherein the stability parameter indicates a variance between outputs for the path during the execution of the artificial intelligence system to process for inputs in the input category; and
monitoring a new flow path parameter in the set of dynamic execution parameters over the period of time, wherein the new flow path parameter indicates an addition of a new path to the paths being monitored that generates the output.

19. The computer program product of claim 18, wherein switching the processing comprises:
switching the processing of the inputs for the input category from the artificial intelligence system to the linear system in response to the stability parameter and the new flow path parameter being within the threshold.

20. The computer program product of claim 17, monitoring the set of dynamic execution parameters comprises:
monitoring the set of dynamic execution parameters for paths in the artificial intelligence system during execution of the artificial intelligence system.
